(19) United States
(12) Patent Application Publication
(10) Pub. No.: US 2012/0311077 A1
(43) Pub. Date: Dec. 6, 2012

(54) Remote Access System and Method

(76) Inventor: Thomas Charvet, San Antonio, TX (US)

(21) Appl. No.: 13/483,486

(22) Filed: May 30, 2012

Related U.S. Application Data
(60) Provisional application No. 61/491,933, filed on Jun. 1, 2011.

(51) Int. Cl. G06F 15/16

(52) U.S. Cl. 709/217

(57) ABSTRACT

A system comprising a system computer, a source portable storage device (PSD), and a remote PSD. The system computer has a computer-readable medium comprising a set of instructions for receiving the address of the source device and a group identifier; storing reported addresses and group identifiers; receiving a query from a remote device comprising the address of the remote device and a group ID; communicating a matching source IP address, if any, to the remote device; communicating the remote address of the remote device, if any, to the corresponding source device. The source PSD has a group identifier, and comprises a set of computer-executable instructions for reporting the address and group identifier of the connected source device to the system computer. The remote PSD comprises a set of instructions for querying the system computer for a source IP address corresponding to the group identifier.

### CROSS REFERENCE TO RELATED APPLICATIONS

This application claims the benefit of U.S. provisional patent application Ser. No. 61/491,933, filed Jun. 1, 2011 and entitled “Remote Access System and Method,” and which is incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention relates to computer technology. More specifically, the present invention is a system and method for remotely accessing one computer from another computer using software embedded in, or otherwise contained on, portable storage devices connectable to the subject computers.

2. Description of the Related Art

Remote desktop access refers to capabilities that allow a computer user to access and operate a first “source,” or “host,” computer through a second “remote” computer. In the age of graphical user interfaces (GUIs), such as those provided by the most popular operating systems, a copy of the screen of the source computer is transmitted to and shown on the remote computer, thus allowing the user to interface with the source computer in much the same manner as if the user was physically present at its location.

When using remote desktop access services, the location of the remote computer relative to the source computer is irrelevant provided that there is a communication path between the two computers. For example, the source and remote computers may be on the same network within a single building. Alternatively, the source and remote computer may be located in different countries and communicate through the internet.

Remote desktop access is driven by software, such as pcAnywhere (developed by Symantec Corporation) or the web-based service provided under the name GoToMyPC (produced by Citrix Online). With software driven systems such as these, terminal server software resides on the source device and listens for communication from authorized remote devices. Separate “client” software on the remote device initiates the remote communication with the terminal server.

One detriment to this kind of remote access is the need to download and install the client software for use on the client computer. Depending on the particular software, terminal services software may also need to be downloaded and installed on the source computer. In some cases, such software may be packaged with the underlying computer operating system, such as the terminal services software provided with Microsoft Windows®.

Other detriments to such software systems include the lack of full portability and the need to configure each installation with the parameters of the particular computers. For example, after host software is installed on a particular computer, that software cannot be also installed on another computer without an inconvenient software uninstallation process, and subsequent installation on a new computer. The software may be disabled by the user, but even that leaves unnecessary software on the device and requires configuring the software accordingly.

### BRIEF SUMMARY OF THE INVENTION

The present invention is a system that allows remote access to an internet-connected device using a portable data storage device (PSD), such as a USB flash drive. The storage device contains all the necessary hardware and embedded software to establish and manage remote access between the computers. In addition, the present invention is fully portable in that, to change computers operating as a source or remote device, the corresponding hardware need simply be disconnected from the computer and then connected to the new computer.

The present invention is a system comprising a system computer, at least one source portable storage device (PSD), and at least one remote PSD. The system computer has a computer-readable medium comprising a set of computer-executable instructions for receiving a report from at least one source device comprising the IP address of the at least one source device and a group identifier; storing reported IP addresses and corresponding group identifiers in a queryable format; receiving a query from at least one remote device comprising the IP address of the at least one remote device and a group ID; communicating a matching source IP address, if any, to the querying remote device; communicating the remote IP address of the querying remote device, if any, to the corresponding source device. The at least one source PSD has a first group identifier, the at least one source PSD being connectable to the at least one source device, the at least one source PSD comprising a set of computer-executable instructions for reporting the IP address and group identifier of the connected source device to the system computer. The at least one remote PSD having the group identifier, the at least one source PSD being connectable to the at least one remote device, the at least one remote PSD comprising a set of computer-executable instructions for querying the system computer for a source IP address corresponding to the group identifier.

The present invention also contemplates a method for establishing remote communication between at least one source device and at least one remote device, the method comprising: a first step of connecting at least one source PSD to the at least one source device, the at least one source PSD having a first group identifier; a second step of transmitting the IP address of the at least one source device and the first group identifier to a system computer executing an auto-location service; a third step of storing the IP address and the corresponding group identifier in a queryable format on the system computer; a fourth step of connecting at least one remote PSD to the at least one remote device, the at least one remote PSD having a second group identifier; a fifth step of querying the auto-location web service for a source IP address matching the second group identifier; a sixth step of communicating the source IP address of the at least one source device from the system computer to the remote device; and a seventh step of communicating the remote IP address of the at least one remote device from the auto-location service to the at least one source device.

### BRIEF DESCRIPTION OF THE SEVERAL VIEWS OF THE DRAWINGS

FIG. 1 is a system diagram of an embodiment of the present invention.

FIG. 2 is a system diagram of another embodiment of the present invention.

### DETAILED DESCRIPTION OF EMBODIMENTS OF THE INVENTION

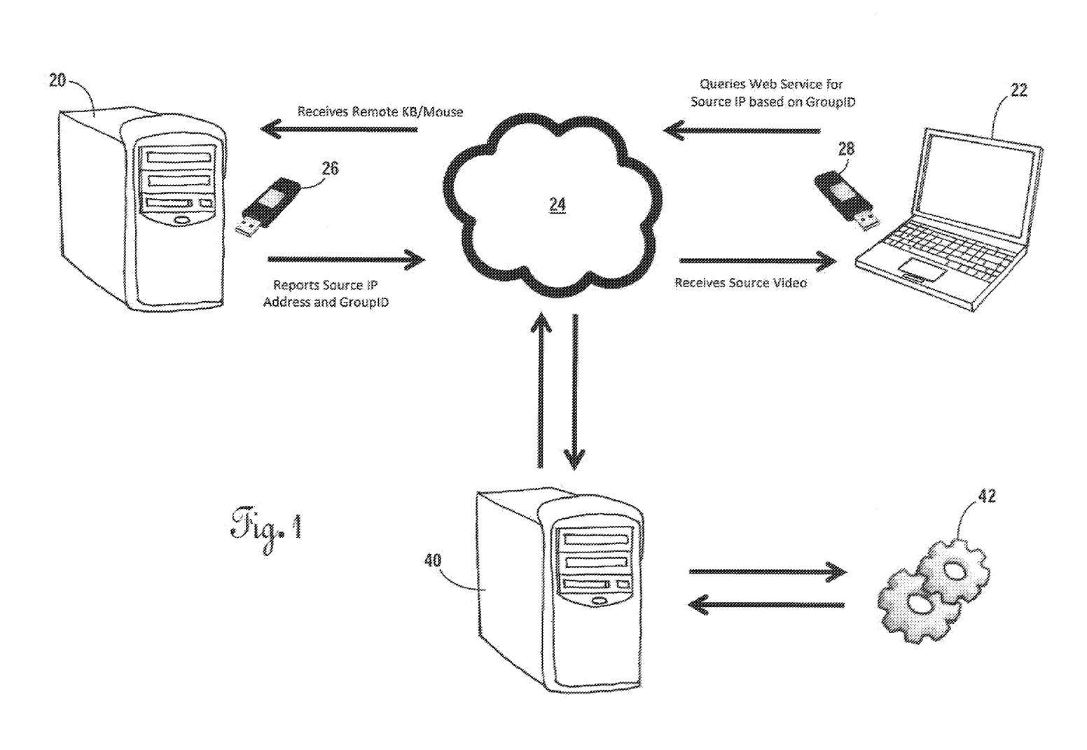

FIG. 1 is a system diagram of the preferred embodiment of the present invention in use with a source device 20 and a remote device 22. The source device 20 and a remote device 22 are not in direct communication, but are each enabled with access to the internet 24 (e.g., through a modem or router).

A source portable storage device (PSD) 26, which is a computer-readable medium, is a USB flash drive on which resides source software and a group identifier. The source software comprises a set of instructions for reporting the IP address of the source device and the group identifier to a system computer 40 running an auto-location service 42.

A remote PSD 28 is also a USB flash drive, on which resides remote software and a group identifier corresponding to the group identifier of the source PSD 26. The remote software comprises a set of instructions for querying the remote auto-location service 42 for a source IP address corresponding to the group identifier.

The auto-location service 42 resides on the system computer 40 that is in communication with the internet 24. The auto-location service 42 comprises a set of instructions for receiving a report from source devices (such as the source device 20) comprising the IP address and group identifier; storing reported IP addresses and corresponding group identifiers in a queryable format; receiving a query from remote devices (such as the remote device 22) comprising the IP addresses and group identifier; communicating a matching source IP address, if any, to the querying source device; and communicating the remote IP address of the querying remote devices, if any, to the source devices.

When the source PSD 26 is connected to the source device 20 (i.e., the source USB flash drive is connected to a USB port of the source device 20), the source software is loaded and executed by the source device 20. The source software causes the source device 20 to report its source IP address and group identifier to the auto-location web service 42 running on the system computer 40.

When the remote PSD 28 is connected to the remote device 22 (i.e., the remote USB flash drive is connected to a USB port of the remote device 22), the remote software is loaded and executed by the remote device 22. The remote software causes the remote device 22 to query the system computer 40 for the corresponding source IP address for the group identifier.

The system computer 40 maintains a database of active source IP addresses and group identifiers. When the system computer 40 receives a query from a remote device, the system computer 40 searches the database for a matching group identifier. If a match is found, the system computer 40 transmits the source IP address to the remote device 22 and transmits the IP address of the remote device 22 to the corresponding source device 20.

Thereafter, because each device knows the IP address of the other devices in the group, communication can be established between the source device 20 and the remote device 22 through the internet 24 using conventional internet protocols. The source device 20 transmits, and the remote device 22 receives source transmissions, including, but not limited to, video, printer instructions, audio output, clipboard access, and interdevice file exchange (i.e., the ability to transfer files between the source device and the remote device), whereas the remote device 22 transmits, and the source device 20 receives, remote transmissions that may include, but are not limited to, keyboard input, mouse inputs, and interdevice file exchange of the remote device 22.

The software resident on the source PSD 26 and remote PSD 28 are fully portable and need not be installed or configured on any particular computer. For example, after a remote communication link is established between a first source device and a first remote device, the source PSD 26 may be removed from the first source device and connected to a second source device, after which remote communication will be established between the second source device and the first remote device. Similarly, after a remote communication link is established between a first source device and a first remote device, the remote PSD 28 may be removed from the first remote device and connected to a second remote device, after which remote communication link will be established between the second remote device and the first source device.

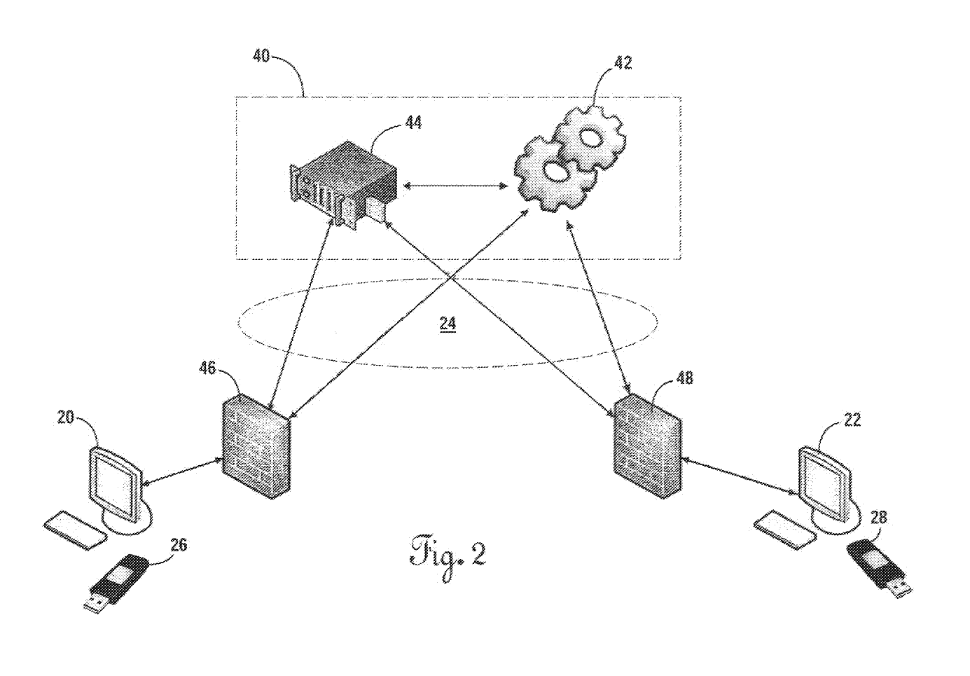

FIG. 2 is a system diagram of another embodiment of the present invention in use with the same source device 20 and a remote device 22 described with reference to FIG. 1. Other reference numbers common to both figures represent identical elements of the embodiments.

Whereas the embodiment described with reference to FIG. 1 may be used when the source device 20 has no firewall or the firewall has been successfully pinholed, the embodiment shown in FIG. 2 may be sued with the source device 20 is firewalled and the firewall cannot be pinholed (e.g., a corporate network). A “pinhole” is a port that is opened through a firewall to allow a particular application to gain controlled access to the protected network.

In addition to the autolocation service 42, the system computer 40 runs a proxy service 44. The autolocation service 42 and proxy service 44 are able to communicate with one another. A source firewall 46 is positioned between the source device 20 and the internet 24. A remote firewall 48 is positioned between the remote device 22 and the internet 24.

As described with reference to FIG. 1, when the source PSD 26 is connected to the source device 20, the source software is loaded and executed by the source device 20. The source software causes the source device 20 to report its source IP address and group identifier to the auto-location web service 42 running on the system computer 40. Thereafter, the source device 20 requests a connection to an external address. If the connection is established, the source device 20 registers an address as described with reference to FIG. 1. If the connection is not established, the source device 20 requests, and thereafter maintains, proxy services from the proxy service 44.

Upon receiving a request from a source device 20 for proxy services, the autolocation service 42 instructs the proxy service 44 to expect a connection from the source device and to assign that connection a connection ID that is associated with the with the source device's group ID. Thereafter, the source device 20 connects to the proxy. In this embodiment, the proxy service 44 is configured to reject all connection attempts except those specifically reserved by the autolocation service 42 for specific addresses. As an additional security measure, the proxy service 42 also rejects all connection attempts, regardless of address, that occur after a predetermined period of time. Thus, connections may be established only during limited period of time after the request for proxy services is made.

When the remote PSD 28 is connected to the remote device 22 (i.e., the remote USB flash drive is connected to a USB port of the remote device 22), the remote software is loaded and executed by the remote device 22. The remote software causes the remote device 22 to query the system computer 40 for the corresponding source IP address for the group identifier.

If the corresponding source device 22 is managed by the proxy server, the autolocation services instructs the proxy to expect a connection from the address of the remote device and connect it to the connection ID of the desired source device. Data is therefore related between the source device 20 and remote device 22 through the proxy server.

The system computer 40 maintains a database of active source IP addresses and group identifiers. When the system computer 40 receives a query from a remote device, the system computer 40 searches the database for a matching group identifier. If a match is found, the system computer 40 transmits the source IP address to the remote device 22 and transmits the IP address of the remote device 22 to the corresponding source device 20. If a match is not found, the autolocation service 42 instructs the proxy to expect a connection from the remote device's address and to connect it to the associated source device's connection ID. The autolocation service 42 then responds to the remote device with the address of the proxy service 44. After which the remote device starts the remote desktop application and connects to the proxy service 44.

Thereafter, because each device knows the proxy IP address of the other firewalled devices in the group, communication can be established between the source device 20 and the remote device 22 through the firewalls 46, 48 and the internet 24 using conventional internet protocols. The source device 20 transmits, and the remote device 22 receives source transmissions, including, but not limited to, video, printer instructions, audio output, clipboard access, and interdevice file exchange (i.e., the ability to transfer files between the source device and the remote device), whereas the remote device 22 transmits, and the source device 20 receives, remote transmissions that may include, but are not limited to, keyboard input, mouse inputs, and interdevice file exchange of the remote device 22.

Still other embodiments contemplate additional features. According to a third embodiment, when the source PSD is connected to, and the software loaded upon, the source device 20, the source device (i) starts a remote desktop application, which provides the user interface; and (ii) creates a software firewall (e.g., Windows firewall) rule. In addition, the software attempts to create a universal plug-and-play (UPnP) connection to a local router.

The source device 20 queries the router to see if a public port mapping already exists to the source-remote desktop application port. If public port mapping does not already exists, the source device creates public port mapping and records the external address.

Thereafter, the source device attempts to connect to the external device. If the connection is successful, the source device registers its name and address as a direct connection as described with reference to FIG. 1. If the connection is not successful, the source device registers its name and requests proxy services from the system computer, as described with reference to FIG. 2.

In this alternative embodiment, when a remote PSD is connected to and its software loaded upon the remote device, the remote device sends a request to the autolocation service for a listing of all source devices that share the group ID of the remote PSD. The autolocation service thereafter provides a listing, from which the user selects the desired source device.

The listing provided by the autolocation service contains information from which the remote device can determine whether the associated source device has requested proxy services. For example, if proxy services were not requested, the address information of the source device may be provided as part of the listing. If the address field is missing, for example, the remote device interprets this to mean that the source device requested proxy service.

If the source device to which the remote device desires to connect requested proxy service, the remote device sends a request to connect to the source device to the autolocation service. Thereafter, the autolocation service instructs the proxy service to expect a connection from the remote device and to associate the remote device with connection ID of the desired source address. Thereafter, the autolocation service sends the address of the proxy server to the remote device, and the remote desktop application is started and connects to the proxy service. This allows for proxy clustering, failover, and migration.

The present invention is described in terms of specifically-described embodiments. For example, the above-described system only refers to a system incorporating one client computer and one host computer. Alternative embodiments of such systems contemplate multiple client computers that may remotely access multiple host computers. Yet other embodiments contemplate multiple system computers being used to implement the autolocation service and proxy service described herein. Moreover, a client PSD may also include the necessary software to act as a host computer.

Those skilled in the art will recognize that alternative embodiments of such systems and methods can be used in carrying out the present invention. Other aspects, features, and advantages of the present invention may be obtained from a study of this disclosure and the drawings, along with the appended claims.

Numbering of steps of the method in the claims is not intended to limit the order in which those steps can be performed, but is for convenience of reference only.

I claim:

1. A system for remote communication between at least one source device and at least one remote device, the system comprising:
a system computer having a computer-readable medium comprising a first set of computer-executable instructions for:
receiving a report from at least one source device comprising the IP address of the at least one source device and a group identifier;
storing reported IP addresses and corresponding group identifiers in a queryable format;
receiving a query from at least one remote device comprising the IP address of the at least one remote device and a group ID;
communicating a matching source IP address, if any, to the querying remote device;
communicating the remote IP address of the querying remote device, if any, to the corresponding source device;
at least one source portable storage device (PSD) having a first group identifier, the at least one source PSD being connectable to the at least one source device, said at least one source PSD comprising a second set of computer-executable instructions for reporting the IP address and group identifier of the connected source device to said system computer;
at least one remote PSD having said group identifier, said at least one source PSD being connectable to the at least one remote device, said at least one remote PSD comprising a third set of computer-executable instructions for querying said system computer for a source IP address corresponding to said group identifier.

2. The system of claim 1 wherein said at least one source PSD further comprises computer-executable instructions for:
receiving remote transmissions from the at least one remote device to the source device, wherein said remote transmissions include at least one of keyboard input, mouse inputs, and interdevice file exchange;
communicating the received remote transmissions to the respective ports of the at least one source device; and
communicating source transmissions from the at least one source device to the at least one remote device, wherein said source transmissions include at least one of video output, printer instructions, audio output, clipboard access, and interdevice file exchange.

3. The system of claim 1 wherein said at least one remote PSD further comprises computer-executable instructions for:
receiving source transmissions from the at least one source device, wherein said source transmissions includes at least one of video output, printer instructions, audio output, clipboard access, and interdevice file exchange.
communicating the received source transmissions to the respective ports of said at least one remote device; and
transmitting remote transmissions of the at least one remote device to the at least one source device, wherein said remote transmissions include at least one of keyboard input, mouse inputs, and interdevice file exchange.

4. The system of claim 1 wherein said first set of computer-executable instructions further comprises the step of assigning a source device a connection ID that is associated with the group ID of the source device when the source device requests proxy service.

5. The system of claim 1 wherein said first set of computer-executable instructions further comprises the step of rejecting all connection attempts from devices having addresses not reserved by the system computer.

6. The system of claim 1 wherein said set of computer-executable instructions further comprises the step of rejecting all connection attempts that occur after a threshold time period following registration of a source device with the system computer.

7. A method for establishing remote communication between at least one source device and at least one remote device, the method comprising:
a first step of connecting at least one source portable storage device (PSD) to the at least one source device, said at least one source PSD having a first group identifier and comprising a set of computer-executable instructions for reporting the IP address and group identifier of the connected source device to a system computer;
a second step of transmitting the IP address of the at least one source device and the first group identifier to a system computer executing an auto-location service;
a third step of storing the IP address and the corresponding group identifier in a queryable format on the system computer;
a fourth step of connecting at least one remote PSD to the at least one remote device, said at least one remote PSD having a second group identifier and comprising a set of computer-executable instructions for querying said system computer for a source IP address corresponding to said group identifier.
a fifth step of querying the auto-location web service for a source IP address matching the second group identifier;
a sixth step of communicating the source IP address of the at least one source device from the system computer to the remote device; and
a seventh step of communicating the remote IP address of the at least one remote device from the auto-location service to the at least one source device.

8. The method of claim 7 further comprising:
an eighth step of communicating remote transmissions of the remote device to the source IP address, wherein said remote transmissions include at least one of keyboard input, mouse inputs, and interdevice file exchange; and
a ninth step of communication source transmissions of the source device to the remote IP address, wherein said source transmissions include at least one of video output, printer instructions, audio output, clipboard access, and interdevice file exchange.

9. The method of claim 7 further comprising:
an eighth step of assigning a connection from a source device a connection ID that is associated with group ID of the source; and
a ninth step of rejecting all connection attempts from source devices having address that have not been reserved by the system computer.

10. The method of claim 7 further comprising:
a tenth step of querying the system computer for source devices assigned a first group ID;
an eleventh step of establishing a connection between a source device and a remote device that have an associated connection ID.
